(19) United States
(12) Patent Application Publication
(10) Pub. No.: US 2016/0125307 A1
(43) Pub. Date: May 5, 2016

(54) AIR QUALITY INFERENCE USING MULTIPLE DATA SOURCES

(71) Applicants: Yu ZHENG, Haidian District, Beijing (CN); Xing XIE, Haidian District, Beijing (CN); Wei-Ying MA, Haidian District, Beijing (CN); Hsiao-Wuen HON, Haidian District, Beijing (CN); Eric I-Chao CHANG, Haidian District, Beijing (CN); MICROSOFT TECHNOLOGY LICENSING, LLC, Redmond, WA (US)

(72) Inventors: Yu Zheng, Beijing (CN); Xing Xie, Beijing (CN); Wei-Ying Ma, Beijing (CN); Hsiao-Wuen Hon, Beijing (CN); Eric I-Chao Chang, Beijing (CN)

(21) Appl. No.: 14/896,344

(22) PCT Filed: Jun. 5, 2013
(86) PCT No.: PCT/CN2013/076749

§ 371 Date: Dec. 4, 2015

(51) Int. Cl. G06N 7/00; G06N 3/08; G06N 99/00

(52) U.S. Cl. CPC G06N 7/005; G06N 99/005; G06N 3/08

(57) ABSTRACT

The use of data from multiple data source provides inferred air quality indices with respect to a particular pollutant for multiple areas without the addition of air quality monitor stations to those areas. Labeled air quality index data for a pollutant in a region may be obtained from one or more air quality monitor stations. Spatial features for the region may be extracted from spatially-related data for the region. The spatially-related data may include information on fixed infrastructures in the region. Likewise, temporal features for the region may be extracted from temporally-related data for the region that changes over time. A co-training based learning framework may be further applied to co-train a spatial classifier and a temporal classifier based at least on the labeled air quality index data, the spatial features for the region, and the temporal features for the region.

### BACKGROUND

Information about urban air quality, such as the concentration of SO₂ and NO₂, plays a role in protecting human health and controlling air pollution. Air quality may vary greatly in urban spaces as air quality is affected by multiple factors, such as meteorology, automobile traffic volume and patterns, and land use in different areas. For example, industrial and commercial areas tend to generate more air pollution than residential areas. Thus, monitoring air quality in an urban environment may require a large number of air quality monitor stations that are distributed throughout the urban environment.

However, there are many obstacles to setting up an adequate number of air quality monitor stations. One obstacle is the cost of building these stations, as well as the cost of permanently staffing and maintaining these air quality monitor stations. Another obstacle is the limited availability of land in an urban environment for the construction of such air quality monitor stations. For example, acquiring land for the construction of air quality monitor stations may be prohibitively expensive or infeasible due to the existing use of the land. An additional obstacle may be the amount of environmental cost associated with the operation of the air quality monitor stations. While the energy consumption of a single air quality monitor station may be small, operating a network of air quality monitor stations may consume a relatively large quantity of energy, and thus may contribute to the very pollution that degrades air quality.

### SUMMARY

Described herein are techniques for inferring air quality information for areas in a region based on historical and real-time air quality data from existing air quality monitor stations, as well as spatial and temporal data from other data sources. The other data sources may provide meteorological data, traffic flow data, human mobility data, road structure data, points of interest data, and/or so forth.

The techniques may use a semi-supervised learning approach based on a co-training framework that trains two separate classifiers, such as a spatial classifier and a temporal classifier. The spatial classifier may take spatially-related features (e.g., the density of the points of interest, lengths of roads, etc.) as input to classify spatial correlations between air qualities at different areas. The temporal classifier may use temporally-related features, such as traffic flow data and meteorological data, to discover the temporal dependency of air qualities at different areas.

The co-training framework may generate inference models, i.e., classifiers, which are used to interpolate air qualities for additional areas based on a limited set of measured air quality data from a small number of areas. The models may be used to infer the air quality of the additional areas based on real-time air quality data from existing air quality monitor stations and other forms of collected spatial or temporal data.

In at least one embodiment, labeled air quality index data for a pollutant in a region may be obtained from one or more air quality monitor stations. Spatial features for the region may be extracted from spatially-related data for the region. The spatially-related data may include information on fixed infrastructures in the region. Likewise, temporal features for the region may be extracted from temporally-related data for the region that changes over time. A co-training based learning framework may be applied to co-train a spatial classifier and a temporal classifier based at least on the labeled air quality index data, the spatial features for the region, and the temporal features for the region.

Accordingly, the techniques may provide air quality data, such as air quality indices for a particular pollutant, for multiple areas without the installation of additional air quality monitor stations in those areas. Such reduction or elimination of the necessity to build air quality stations may provide monetary and energy savings. Further, the techniques may be used to determine areas at which future air quality monitor stations are to be established, such as in areas which the techniques predict worse than expected air quality.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a block diagram that illustrates an example scheme for using spatial and temporal classifiers to infer air quality indices for multiple areas in a region based on multiple sources of data.

FIG. 2 is an illustrative diagram that shows example components of a computing device that supports the inference of air quality indices for multiple areas in a region based on multiple sources of data.

FIG. 3 is a schematic diagram that illustrates an operating principle for implementing the inference of air quality indices for multiple areas in a region based on multiple sources of data.

FIG. 4 is a schematic diagram that illustrates a 3-dimensional grid space of deviations that assists in identifying areas in a region for air quality monitor station installation.

FIG. 5 is a flow diagram that illustrates an example process for training a temporal classifier and a spatial classifier that are used to infer quality indices for a pollutant in a region based on multiple sources of data.

FIG. 6 is a flow diagram that illustrates an example process for using a temporal classifier and a spatial classifier to infer an air quality index for a pollutant in an area based on multiple sources of data.

FIG. 7 is a flow diagram that illustrates an example process for using deviations between obtained air quality index levels and linear interpolation levels of pollutants to determine possible areas for air quality monitor station installation.

### DETAILED DESCRIPTION

Described herein are techniques for inferring air quality information for areas in a region based on historical and real-time air quality data from existing air quality monitor stations, as well as spatial and temporal data from other data sources. The other data sources may include meteorological data, traffic flow data, human mobility data, road structure data, points of interest data, and/or so forth.

The techniques may use a semi-supervised learning approach based on a co-training framework that trains two separate classifiers, such as a spatial classifier and a temporal classifier. The spatial classifier may take spatially-related features (e.g., the density of the points of interest, lengths of roads, etc.) as input to classify spatial correlations between air qualities at different areas. In some embodiments, the spatial classifier may be based on an artificial neural network. The temporal classifier may use temporally-related features, such as traffic flow data and meteorological data, to discover the temporal dependency of air quality at different areas. In some embodiments, the temporal classifier may be a linear-chain conditional random field (CRF).

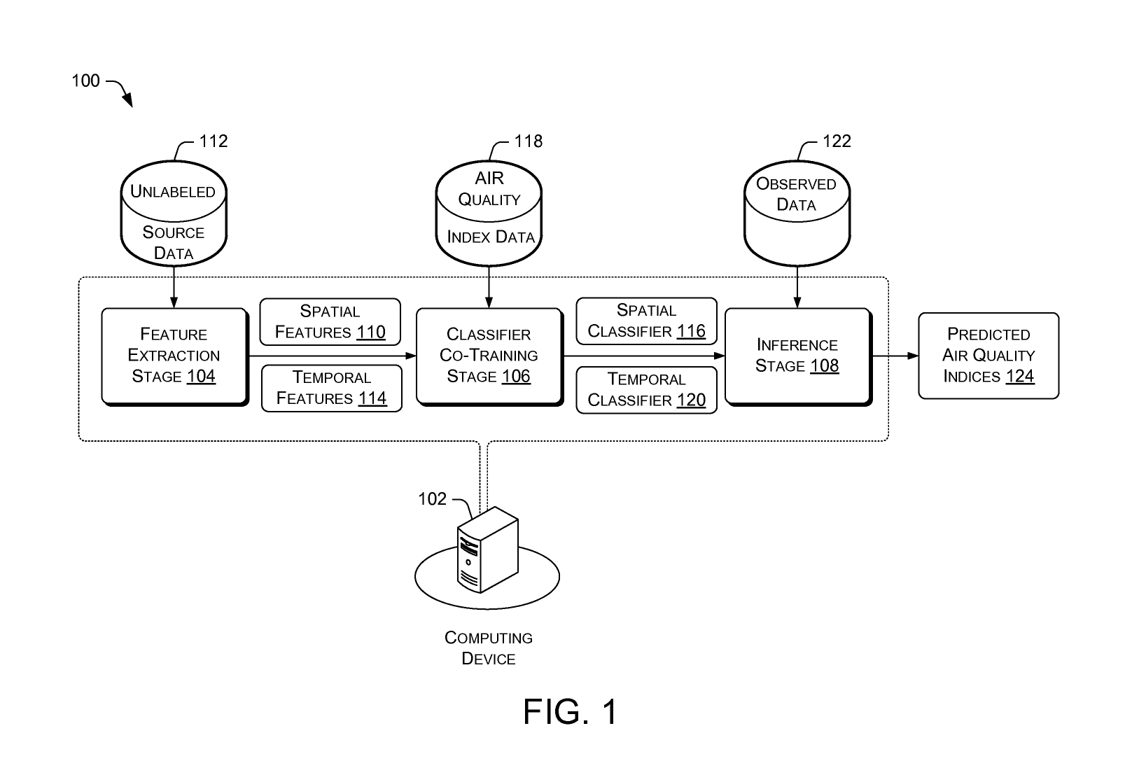

The co-training framework may generate inference models that are used to interpolate air quality for additional areas based on a limited set of measured air quality data from a small number of areas. The models may be used to infer the air qualities of the additional areas based on real-time air quality data from existing air quality monitor stations and other forms of collected spatial or temporal data. Examples of techniques for inferring real-time air quality information for areas without air quality monitor stations in accordance with various embodiments are described below with reference to FIGS. 1-7.

### Example Scheme

FIG. 1 is a block diagram that illustrates an example scheme 100 for using spatial and temporal classifiers to infer air quality indices (AQIs) for multiple areas in a region based on multiple sources of data. The multiple areas for which AQIs are inferred may lack air quality monitor stations. Further, a corresponding AQI may be inferred for each of multiple pollutants that can be present in a particular area. For example, a first AQI may be inferred for the pollutant SO₂ in an area, while a second AQI may be inferred for the pollutant NO₂ in the same area. The example scheme 100 may be implemented by a computing device 102. The computing device 102 may be a general purpose computer, such as a desktop computer, a tablet computer, a laptop computer, one or more servers, and so forth.

The example scheme 100 may include a feature extraction stage 104, a classifier co-training stage 106, and an inference stage 108. During feature extraction stage 104, spatial features 110 may be extracted from spatially-related data of the unlabeled source data 112, and temporal features 114 may be extracted from the temporally-related data of the unlabeled source data 112. In various embodiments, the spatially-related data may include road network data, points-of-interest (POI) data, and/or other data regarding fixed infrastructures in a region. The temporally-related data may include data that changes over time in the region. For example, the temporally-related data may include automobile traffic data, human movement data, meteorological data, and/or so forth. In some instances, human movement may be tracked via changes in the locations of cellular phones. The changes in the locations of cellular phones are the result of human movements by walking, by taking buses, by riding subways, and/or using other forms of transportation.

The classifier co-training stage 106 may involve the co-training of a spatial classifier 116 based on the spatial features 110 and air quality index data 118. The air quality index data 118 may be air quality index levels that are obtained by air quality monitor stations in the region for a particular pollutant. Accordingly, the air quality index data 118 may constitute labeled data. Likewise, the training of a temporal classifier 120 may be based on the temporal features 114 and the air quality index data 118. The co-training of the spatial classifier 116 and the temporal classifier 120 may be performed using a semi-supervised learning technique that considers multiple views of data.

During the inference stage 108, the trained spatial classifier 116 and the trained temporal classifier 120 may be used to infer AQIs for areas in the region that do not have air quality monitor stations. The trained spatial classifier 116 may be applied to the spatial features that are extracted from observed data 122 for each area in the region to generate a corresponding spatial probability score. Likewise, the trained temporal classifier 120 may be applied to the temporal features that are extracted from the observed data 122 for each area in the region to generate a corresponding temporal probability score. The observed data 122 may include real-time spatially-related data and real-time temporally-related data. The temporal probability scores and the spatial probability scores of each area may be further combined to predict an AQI level for the area. In various embodiments, the real-time spatially-related data may include road network data, points-of-interest (POI) data, and/or other data regarding fixed infrastructures in a region. The real-time temporally-related data may include data that changes over time in the region. For example, the real-time temporally-related data may include automobile traffic data, human movement data, meteorological data, and/or so forth.

Accordingly, predicted AQIs 124 may be generated for multiple areas in the region, including areas that lack air quality monitor stations. The determination of the predicted AQIs 124 for the multiple areas may be performed repeatedly at predetermined time intervals. Further, corresponding AQIs may also be predicted for multiple pollutants that can be present in a single area in the same manner. For example, a first AQI level may be inferred for the pollutant SO₂ in an area, while a second AQI level may be inferred for the pollutant NO₂ in the same area. Thus, a spatial classifier and a temporal classifier are co-trained to infer AQIs for a particular pollutant, and the inference of AQIs for multiple pollutants may be based on the use of multiple trained spatial classifiers and multiple trained temporal classifiers.

In some instances, the predicted AQIs for multiple pollutants that are present in a plurality of areas in the region over multiple predetermined time intervals may be used for further determination. Such determination may be related to whether one or more of the areas in the region are suitable for air quality monitor station installation. In such instances, the determination may be performed using a skyline detection technique.

### Example Components

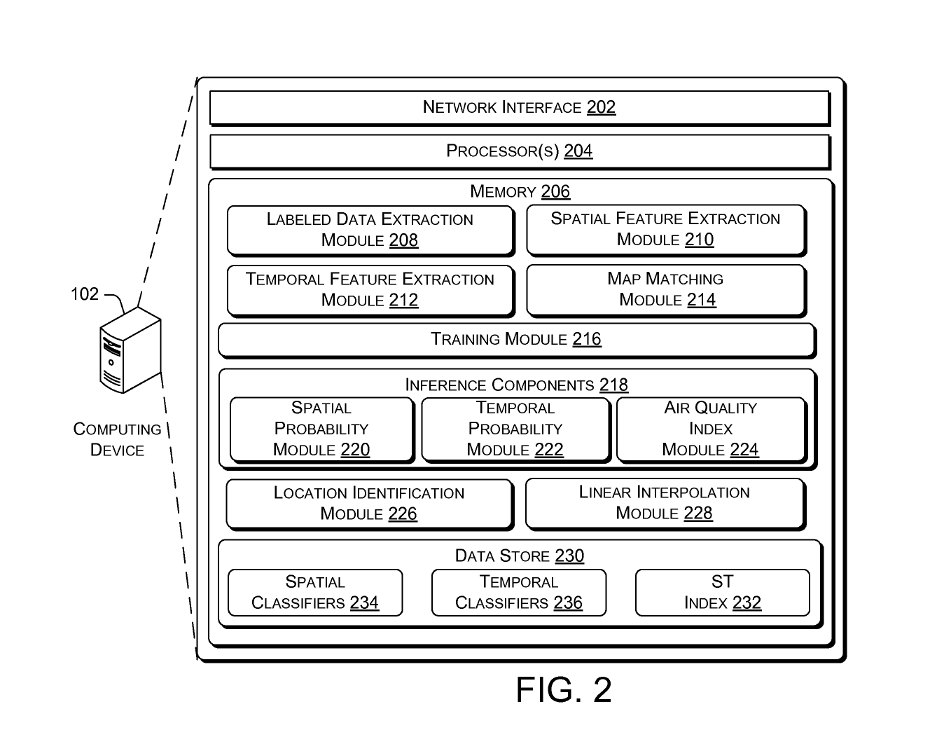

FIG. 2 is an illustrative diagram that shows example components of a computing device that supports the inference of air quality indices for multiple areas in a region based on multiple sources of data. In various embodiments, the computing device 102 may be a server, a group of servers, a general purpose computer, such as a desktop computer, a tablet computer, a laptop computer, and so forth. However, in other embodiments, the computing device 102 may be one of a smart phone, a game console, a personal digital assistant (PDA), and so forth.

Example computing device 102 includes a network interface 202, one or more processors 204, memory 206, and/or user interfaces that enable a user to interact with the computing device. The network interface 202 may include wired and/or wireless communication interface components that enable the computing device 102 to transmit and receive data via a network. The user interfaces may include a data output device (e.g., visual display, audio speakers), and one or more data input devices. The data input devices may include, but are not limited to, combinations of one or more of keypads, keyboards, mouse devices, touch screens, microphones, speech recognition packages, and any other suitable devices or other electronic/software selection methods.

In various embodiments, the wireless interface components may include, but is not limited to cellular, Wi-Fi, Ultra-wideband (UWB), Bluetooth, satellite transmissions, and/or so forth. The wired interface components may include a direct input/output (I/O) interface, such as an Ethernet interface, a serial interface, a Universal Serial Bus (USB) interface, and/or so forth. As such, the computing device 102 may have network capabilities. For example, the computing device 102 may exchange data with other electronic devices (e.g., laptops computers, servers, etc.) via one or more networks, such as the Internet. In this way, the computing device 102 may obtain the unlabeled source data 112, the air quality index data 118, and the observed data 122 from various data sources, such as data servers and/or data clouds.

The memory 206 may be implemented using computer-readable media, such as computer storage media. Computer-readable media includes, at least, two types of computer-readable media, namely computer storage media and communication media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium that may be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

The memory 206 of the computing device 102 may store components that include a labeled data extraction module 208, a spatial feature extraction module 210, a temporal feature extraction module 212, a map matching module 214, and a training module 216. The inference components 218 stored in the memory 206 may include a spatial probability module 220, a temporal probability module 222, and an air quality index module 224. The memory 206 may further store a location identification module 226 and a linear interpolation module 228. The components that are stored in the memory 206 may be executable by the processors 204 to perform functions and tasks. The memory 206 may also include a data store 230.

The labeled data extraction module 208 may obtain air quality information from air quality monitor stations that are located in various areas of a region. In various embodiments, the region may be a city, and the areas may be grids that are in the region. For example, a region may be divided into grids (e.g., 1 km×1 km). Each grid g may have a geospatial coordinate g.loc and a set of AQI labels g.Q={q₁, q₂, . . . , qₖ} that are associated with the grid or are to be inferred for the grid. Further, k may denote the type of pollutant, and qₖε [symbol] may represent the AQI label of the k-th type of pollutant, such as PM₁₀. Accordingly, if an air quality monitor station is located in an area, the labeled data extraction module 208 may label the area with the one or more air quality indices (AQIs) that are reported from the station to generate labeled data. The observed air quality of an area may be affected by the data (e.g., trajectories and POIs) observed in an affecting region g.R that includes the area. For example, an affecting region g.R may include the grid and a predetermined number of neighbor grids (e.g., eight neighboring grids).

An AQI may be a value that is used by a government agency to communicate to the public the current pollution level in the environment. As the AQI increases, an increasingly larger percentage of the population is likely to experience more severe adverse health effects. Functions that are used to convert air pollutant concentrations to AQIs may vary according to pollutant, and may be different in different countries. In some instances, AQI values may be divided into ranges, in which each range is assigned a level and a color code. The descriptor of each AQI level may be regarded as the class to be inferred, i.e., C={G, M, U-S, U, V-U, H}, as shown in the table below:

TABLE I
AQI Values, Levels, and Color Codes

| AQI Values | Levels of Health Concern | Colors |
|---|---|---|
| 0-50 | Good (G) | Green |
| 51-100 | Moderate (M) | Yellow |
| 101-150 | Unhealthy for sensitive | Orange |
| | groups (U-S) | |
| 151-200 | Unhealthy (U) | Red |
| 201-300 | Very unhealthy (VU) | Purple |
| 301-500 | Hazardous (H) | Maroon |

The spatial feature extraction module 210 may extract spatial features from data regarding fixed structures that are included in the unlabeled source data 112. The data sources may include a road network data source, a points-of-interest (POI) data source, and/or so forth. The structure of a road network may correlate with its traffic patterns. Accordingly, the spatial feature extraction module 210 may extract multiple features for each area (e.g., grid) based on a road network database, such as a mapping or navigation database. The multiple features may include a total length of highways fₕ, a total length of other (low-level) road segments fᵣ, and the number of intersections fₛ in the area. An increase of road segments in an area may degrade the air quality of an area more significantly than an increase in highway segments. Accordingly, highways may be considered greener than other road segments in terms of generating air pollutants.

The spatial feature extraction module 210 may further extract POI-related features. The categories of POIs and their density in an area may indicate the land use and the function of the area, as well as the traffic patterns in the area. Accordingly, POIs may contribute to the air quality inference of the area. Some POIs may have direct causal relationships with air quality. For example, if an area has multiple chemical factories, the air quality in the area may be degraded. However, a park with green space usually leads to good air quality. Accordingly, the spatial feature extraction module 210 may identify the following example features for each area (e.g., grid):

TABLE II
Categories of POIs

C₁: Vehicle Services (gas stations, repair)
C₂: Transportation spots
C₃: Factories
C₄: Decoration and furniture markets
C₅: Food and beverage
C₆: Shopping malls and Supermarkets
C₇: Sports
C₈: Parks
C₉: Culture & education
C₁₀: Entertainment
C₁₁: Companies
C₁₂: Hotels and real estates

The spatial feature extraction module 210 may extract features related to the amount of vacant spaces in the POIs. In various embodiments, the spatial feature extraction module 210 may divide a grid into a predetermined number of smaller cells, and count the number of cells without a POI. In short, the more vacant places contained in an area, the more likely that air pollutants may be dispersed in the area.

The spatial feature extraction module 210 may also track the change in the number of POIs in each area over time. For example, the spatial feature extraction module 210 may compare the POI data of two consecutive quarters, and calculate the change in the number of POIs in the following five categories (C₃, C₄, C₆, C₈, and C₁₂) in each area. A change may imply construction during which infrastructure was built or removed from an area. Construction is one of the major sources of air pollutants, such as PM₁₀ and NO₂, and the spatial feature extraction module 210 may represent such changes as spatial features.

The temporal feature extraction module 212 may extract temporal features from various environmental or human movement data of the unlabeled source data 112. The concentration of air pollutants may be influenced by meteorology. Accordingly, the temporal feature extraction module 212 may identify, for example, five categories of features: temperature, humidity, barometric pressure, wind speed, and weather (such as cloudy, foggy, rainy, sunny, and snowy). For example, high wind speed may disperse the concentration of PM₁₀, and high humidity may result in a high concentration of Mo. High pressure may result in a relative good AQI. A relatively good AQI may also be present when pressure is high and temperature is low.

Further, the temporal feature extraction module 212 may extract features that are related to traffic flow. Automobile traffic is generally considered a major source of air pollutants that damage air quality. The temporal feature extraction module 212 may calculate multiple features for each area based on spatial trajectories of vehicles traversing an area in a predetermined amount of time (e.g., each hour).

The multiple temporal features may include, for example, expectations of speeds for the vehicles: E(V). In some embodiments, the vehicles may be taxis, as they operate in wide geographical areas and throughout all hours. For example, given a spatial trajectory generated by a vehicle, the temporal feature extraction module 212 may retrieve points that fall in an affecting region of each grid (e.g., p.lεg.R). The temporal feature extraction module 212 may further calculate the distance between any two consecutive points, and compute the speed of each vehicle at each point (pᵢ) according to the equation:

$${p}_{i} \cdot v = \frac{Dist ( {p}_{i} \cdot l , {p}_{i + 1} \cdot l )}{\vert {p}_{i + 1} \cdot t - {p}_{i} \cdot t \vert} \qquad ( 1 )$$

However, as the sampling rate of a global positioning system (GPS) device in each vehicle is different, the temporal feature extraction module 212 may calculate the expected speed with respect to time as follows (which denotes the overall travel speed of vehicles in g.R):

$$E ( v ) = \frac{{\sum }_{{p}_{i} \cdot l ∈ g \cdot R} {p}_{i} \cdot v \times \vert {p}_{i + 1} \cdot t - {p}_{i} \cdot t \vert}{{\sum }_{{p}_{i} \cdot l ∈ g \cdot R} \vert {p}_{i + 1} \cdot t - {p}_{i} \cdot t \vert} \qquad ( 2 )$$

The multiple features may include standard deviation of speeds: D(v). The temporal feature extraction module 212 may calculate such a feature as follows:

$$D ( v ) = \sqrt{\frac{{\sum }_{{p}_{i} \cdot l ∈ g \cdot R} {[ {p}_{i} \cdot v - E ( v ) ]}^{2} \times \vert {p}_{i + 1} \cdot t - {p}_{i} \cdot t \vert}{{\sum }_{{p}_{i} \cdot l ∈ g \cdot R} \vert {p}_{i + 1} \cdot t - {p}_{i} \cdot t \vert}} \qquad ( 3 )$$

which reflects how variably different vehicles were traveling in g.R in a predetermined amount of time (e.g., the past hour), in which the standard deviation may be normalized based on time. The multiple temporal features may further include the distribution of speeds P(v).

The temporal feature extraction module 212 may discretize the speed into multiple intervals of standard units, such as kilometers per hours (e.g., 0≦v<20, 20≦v<40, and v≧40), and calculate the distribution of speeds over the multiple intervals via the following equation:

$$P ( {v}_{1} \leq v < {v}_{2} ) = \frac{{\sum }_{{p}_{j} \cdot l ∈ g \cdot R ⋀ {v}_{1} \leq {p}_{j \cdot v} < {v}_{2}} \vert {p}_{j + 1} \cdot t - {p}_{j} \cdot t \vert}{{\sum }_{{p}_{i} \cdot l ∈ g \cdot R} \vert {p}_{i + 1} \cdot t - {p}_{i} \cdot t \vert} \qquad ( 4 )$$

In some instances, a bigger D(v) may correlate with better air quality while a smaller D(v) may correlation with a worse AQI level for NO₂. This may be due to the fact that if there are no traffic jams, vehicles may travel with different speeds on various roads e.g., vehicles traveling on highways (with a speed limit of 122 km/h) may move much faster than those on a local street (usually with a speed limit of 40 km/h). As an area may contain road segments of different speed limits, D(v) tends to be large when the traffic condition in the area is good. On the contrary, since every vehicle has to move very slowly in a traffic jam, this may lead to a smaller D(v). Thus, traffic jams may cause heavier air pollution than normal traffic conditions.

The temporal feature extraction module 212 may extract features that are related to human mobility denoted by Fₕ.Fₕ. These features may include two feature sets, one set denoting the number of people arriving (fₐ) at an affecting region g.R and the other set denoting the number of people departing from (fₗ) the affecting region g.R in a predetermined amount of time (e.g., a past hour). In general, people themselves are not major air pollutant generators. However, human mobility may imply useful information, such as land use of an area, traffic flow in an area, and land use of a region, such as residential or commercial, each of which may affect air quality inference. In at least one embodiment, the temporal feature extraction module 212 may extract the two feature sets from vehicle trajectories (e.g., taxi trajectory) because such data encode the pickup and drop off points of each trip. However, in other embodiments, the temporal feature extraction module 212 may extract the two feature sets from other data sources or a combination of multiple datasets, such as mobile phone signals of multiple users. Generally speaking, the concentration of PM₁₀ in a grid g may become denser when the number of people arriving at and departing from g.R increases. However, very small fₐ and fₗ may indicate that a corresponding AQI of an area may be either very good or very bad. This may be due to the fact that such places may either be nature parks (good) or factories (very bad) that relatively few people visit.

While the traffic-related and human mobility features may be calculated online, the feature extraction by the temporal feature extraction module 212 can be time consuming. To address this issue, the temporal feature extraction module 212 may use a spatial-temporal (ST)-index 232 of the areas (e.g., grids) and the trajectories, in which each area is associated with two first-in-first-out lists respectively storing the vehicle identifiers of the vehicles traversing an area and the pickup/drop-off points encompassed in the area in a predetermined amount of time (e.g., a past hour). The temporal feature extraction module 212 may sort the two lists by arrival time and pickup/drop-off time respectively. In such an embodiment, the trajectory data of a vehicle may be connected to the vehicle identifier by a hash table. Given an affecting region consisting of multiple areas, the temporal feature extraction module 212 may merge the vehicle identifiers encompassed in these areas by checking the sorted list, and retrieving the point data within a time interval from each trajectory by searching the hash table.

The map matching module 214 may access the received spatial trajectories of vehicles (e.g., taxis) and map each trajectory onto a road network using a map-matching algorithm. The map matching module 214 may store the mapped data in a trajectory database. The mapped data may be used by the training module 216 for offline learning and geo-indexed to improve the efficiency of online inference operations performed by the inferences component 218.

The training module 216 may train a spatial classifier and a temporal classifier based on the labeled data in the forms of known AQIs for areas in a region and the extracted spatial and temporal features. The spatial classifier may be the spatial classifier 116, and the temporal classifier may be the temporal classifier 120.

In some embodiments, the spatial classifier may be an artificial neural network (ANN)-based spatial classifier that uses the spatial features and the AQIs to model the spatial correlations between air qualities of different areas. The spatial classifier may consists of two parts: an input generation phase and an artificial neural network (ANN) phase, in which Fₚ^{k}, Fᵣ^{k}, l^{k}, and c^{k} may respectively denote the POI features, road network features, area, and the AQI label of grid k, and x may denote the labels to be inferred. D₁ may represent a distance function between features (e.g., Pearson correlations) and dₖₓ may be calculated as the geo-distance between the center of two grids, as follows:

ΔPₖₓ=Pearson_Cor(Fₚ^{k},Fₚ^{x}), (5)

ΔRₖₓ=Pearson_Cor(Fᵣ^{k},Fᵣ^{x}), (6)

dₖₓ=Geo_Distance(l^{k},l^{x}). (7)

In the input generation phase, the spatial classifier may randomly choose n grids (e.g., n=3) with labels [symbol] ₁=(g₁, g₂, . . . , gₙ), [symbol] ₁εG₁, to pair with the grid to be inferred. The input of the ANN is calculated according to Equation 5 to 7. To learn the impact of different scales of distance between grids, the pairwise process may be implemented m times to formulate a collection of inputs. The labeled grids involved in each round of input formulation includes at least e different grids from existing grids, formally defined as: [symbol] ={ [symbol] ₁, [symbol] ₂ . . . , [symbol] ₘ}, ∀ [symbol] ᵢ, [symbol] ⱼε [symbol] , | [symbol] ᵢ∩ [symbol] ⱼ|≦e, e.g., e=2 and n=3 means at least one out of the three grids is different from those used in a previous round. The use of the different grids may vary the input. As the POI and road network features extracted from a grid are static, the input (ΔPₙₓ, dₙₓ, ΔRₙₓ) do not change over c^{k} if the same grids are selected each time.

In the ANN phase, the spatial classifier may be in the form of a Back-propagation (BP) neural network with one hidden layer. Accordingly, the training module 216 may set a linear function for the neurons (each of which accepts all the features) in the input layer and a sigmoid function φ(x) for the neurons in the hidden and output layers, which may be formally defined as follows:

c^{k}=φ(Σᵣwᵣφ(Σ_{q}w′_{qr}·(Σₚfₚw_{pq}+b_{q})+b′ₙ)+b″) (8)

in which fₚ may represent a feature of input, bₘ, b′ₙ, and b″ may be the biases associated with the neuron in different layers, and w_{pq}, w′_{qr}, and wᵣ may denote the weight associated with the input of different layers.

In some embodiments, the temporal classifier may be a linear-chain conditional random field (CRF), which is a discriminative undirected probabilistic graphical model for parsing sequential data. The temporal classifier may also be in the form of hidden Markov models (HMMs) or maximum entropy Markov models. However, the advantage of CRFs over hidden Markov models is the relaxation of the independence assumptions between features. Additionally, CRFs may avoid the label bias problem exhibited by maximum entropy Markov models.

A graphical structure G of the temporal classifier may consist of multiple (e.g., two) kinds of nodes G=(X,Y). The nodes Y={Y₁, Y₂, . . . , Yₙ} may represent hidden state variables to be inferred given the sequence of observations denoted by nodes X={X₁, X₂, . . . , Xₙ}, Xᵢ={Fₘ, Fₜ, Fₕ, t} (t is a timestamp by hour, e.g., 8 a.m.). The YᵢεY are structured to form a chain with an edge between each Yᵢ₋₁ and Yᵢ, as well as having an AQI “label” belonging to [symbol] . When conditioned on X, the random variables Yᵢ may obey the Markov property with respect to the graph G:

P(Yᵢ|X,Yⱼ,i≠j)=P(Yᵢ|X,Yⱼ,i˜j) (9)

in which i˜j means i and j are neighbors in G.

The probability of a particular label sequence y given an observation sequence x may be defined as a normalized product of potential functions as follows:

exp(Σⱼλⱼtⱼ(yᵢ₋₁,yᵢ,x,i)+Σₖμₖsₖ(yᵢ,x,i)) (10)

in which tⱼ(yᵢ₋₁,yᵢ,x,i) may represent a transition feature function of the entire observation sequence, the label at positions i and i−1; sₖ(yᵢ,x,i) may be a state feature function of the label at position i, and the observation sequence; λⱼ and μₖ may be parameters estimated from the training data.

Taking into account sₖ(yᵢ,x,i)=sₖ(yᵢ₋₁,yᵢ,x,i), the Equation (10) may be transformed into:

$$P ( y \vert x , λ ) = \frac{1}{Z ( x )} exp ( {\sum }_{j} {λ}_{j} {f}_{j} ( {y}_{i - 1} , {y}_{i} , x , i ) ) , \qquad ( 11 )$$

in which Z(x) may be a normalized factor. This may be informally thought of as measurements on the input sequence that partially determine the likelihood of each possible value for Yᵢ. The temporal classifier may assign a numerical weight to each feature and combine the numerical weights to determine the probability of a certain value for Yᵢ. Accordingly, given k sequences of the training data {(x^{(k)}, y^{(k)})}, the training module 216 may determine the parameters A by maximum likelihood learning P(y|x,λ), which may be solved by gradient descent as follows:

$$L ( λ ) = {\sum }_{k} [ log \frac{1}{Z ( x )} + {\sum }_{j} {λ}_{j} {f}_{j} ( {y}_{i - 1} , {y}_{i} , x , i ) ] . \qquad ( 12 )$$

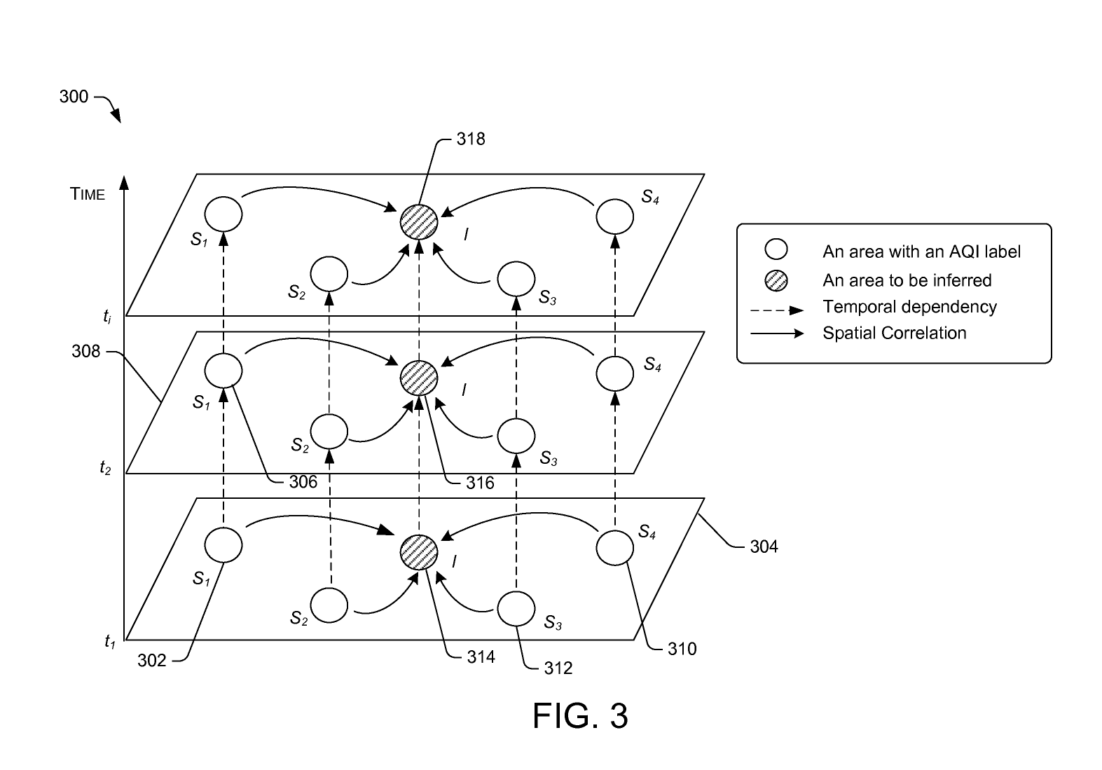

Co-training of a spatial classifier and a temporal classifier is a semi-supervised learning technique that is based on multiple views of the data. The co-training is implemented based on the assumption that each example is described using two different feature sets that provide different and complementary information about an instance. Ideally, the two feature sets of each instance are conditionally independent given the class, and the class of an instance can be accurately predicted from each view alone. Co-training may generate a better inference result as one of the classifiers may correctly label data that the other classifier previously misclassified. The operating principle of co-training may be further illustrated in FIG. 3.

FIG. 3 is a schematic diagram 300 that illustrates an operating principle for implementing the inference of air quality indices for multiple areas in a region based on multiple sources of data. In FIG. 3, a circle may denote an area and a plane may represent the states of these areas at a particular time in terms of air quality. Air quality may have temporal dependency on its current observation and its previous state. For example, the AQI for an area tends to be good if the AQI of the area in the past hour is also good. For example, the AQI 302 of an area at time t₁ (denoted by plane 304) may closely resemble the AQI 306 of the area at time t₂ (denoted by plane 308). Second, the air quality of an area is also affected by its spatial neighbors. For instance, the AQI 310 of an area is likely to be bad if the air quality (e.g., AQI 312) at a place close to the area is also bad. In other words, the AQI for an area is determined by the air pollutants emanating from the area and air pollutants propagated by other areas. Thus, temporal dependency and spatial correlation may be combined to provide inferred AQIs for areas, such as the AQIs 314-318, without explicit AQI data.

Returning to FIG. 2, the training module 216 may feed the spatial classifier and the temporal classifier into a co-training based semi-supervised learning algorithm that is implemented by the module. The learning algorithm may be implemented as follows, in which SC represents the spatial classifier and TC represents the temporal classifier:

Input: A set of features (Fₘ, Fₜ, Fₕ, Fᵣ, Fₚ), some labeled grids G₁, and a

set of unlabeled grids G₂, a threshold θ controlling the
rounds

Output: The spatial classifier SC and temporal classifier TC.
1. i ← 0;
2. Do

| | |
|---|---|
| 3. | SC ← SC.Learning (Fᵣ, Fₚ, G₁); |
| 4. | TC ← TC.Learning (Fₘ, Fₜ, Fₕ, G₁); |
| 5. | Apply SC to each g ∈ G₂, for each class cᵢ, pick nᵢ grids that SC |

most confidently classifies as cᵢ, and add them to G₁.

| | |
|---|---|
| 6. | Apply TC to each g ∈ G₂, for each class cᵢ, pick nᵢ grids that TC |

most confidently classifies as cᵢ, and add them to G₁.

| | |
|---|---|
| 7. | i++; |

8. Until G₂ is empty or i > θ;
9. Return SC and TC;

In other words, the training module 216 may initially train the two classifiers with two separate sets of features. For example, the spatial classifier may be initially trained using the spatial features, and the temporal classifier may be initially trained with the temporal features. The training module 216 may then use the trained spatial classifier and the trained temporal classifier to infer unlabeled grids G₂ iteratively. The iterations may involve adding the most confidently classified examples into the labeled dataset G₁ for the next round of training, until G₂ becomes empty or a predetermined number of rounds θ have been performed. At the end of the iterations, the training module 216 may return the fully trained spatial classifier and the fully trained temporal classifier.

However, in alternative embodiments, the training module 216 may simply train the spatial classifier or the temporal classifier with respect to their respective features for direct use in ascertaining the AQI of a pollutant. In other words, the training module 216 may train the spatial classifier or the temporal classifier independently using a semi-supervised learning technique without the application of the co-training based learning framework.

The inference components 218 may include a spatial probability module 220, a temporal probability module 222, and an air quality index module 224. The spatial probability module 220 may compute a spatial probability score for each area (e.g., grid) using a trained spatial classifier based on the spatial features that are extracted from spatial data sources.

In various embodiments, the spatial probability module 220 may pair a grid to be inferred with designated sets of n labeled grids, and predict an AQI label for each set. The frequency of each inferred label may then be used as the probability score of the label, and the most frequently occurring label may be selected as the final prediction result. The prediction of the spatial classifier may be regarded as a non-linear interpolation over geo-spaces, considering the road network and POIs of these areas.

The temporal probability module 222 may compute a temporal probability score for each area (e.g., grid) using a trained temporal classifier based on the temporal features that are extracted from temporal data sources. As described above, the probability of a particular label sequence y given observation sequence x may be defined as a normalized product of potential functions as follows:

exp(Σⱼλⱼtⱼ(yᵢ₋₁,yᵢ,x,i)+Σₖμₖsₖ(yᵢ,x,i)) (13)

in which tⱼ(yᵢ₋₁,yᵢ,x,i) may be a transition feature function of the entire observation sequence, the label at positions i and i−1; sₖ(yᵢ,x,i) may be a state feature function of the label at position i, and the observation sequence; λⱼ and μₖ may be parameters estimated from the training data.

Taking into account sₖ(yᵢ,x,i)=sₖ(yᵢ₋₁,yᵢ,x,i), the Equation (13) may be transformed into:

$$P ( y \vert x , λ ) = \frac{1}{Z ( x )} exp ( {\sum }_{j} {λ}_{j} {f}_{j} ( {y}_{i - 1} , {y}_{i} , x , i ) ) , \qquad ( 14 )$$

in which Z(x) may represent a normalized factor. This factor may be informally thought of as measurements on the input sequence that partially determine the likelihood of each possible value for Yᵢ. The temporal classifier may assign a numerical weight to each feature and combine the numerical weights to determine the probability of a certain value for Yᵢ.

The air quality index module 224 may predict the AQI of a pollutant in an area (e.g., grid) based on the probability scores generated by the spatial probability module 220 and the temporal probability module 222 (P_{SC} and P_{TC}), respectively. In various embodiments, the air quality index module 224 may multiply P_{SC} and P_{TC} as follows:

c=arg_{c}_{ᵢ}_{ε} [symbol] Max(P_{sc}^{c}^{ᵢ}×P_{Tc}^{c}^{ᵢ}). (15)

Thus, by multiplying the two probability scores P_{SC} and P_{TC}, the air quality index module 224 may select the most possible class as a label. In at least one embodiment, the air quality index module 224 may conduct the inference on a periodic basis (e.g., every hour), based on a schedule at which air quality monitor stations generate air quality reports.

However, in some alternative embodiments, the air quality index module 224 may calculate the AQI of an area with respect to a pollutant by directly applying the spatial classifier to the spatial features of the area. For example, the spatial classifier may pair an area to be inferred with designated sets of n labeled areas, and predict an AQI label for each set. Accordingly, the most frequently occurring label may be selected as the final prediction result for the AQI. However, in other instances, the spatial classifier may use other classification techniques to infer the AQI based on the spatial feature. In such alternative embodiments, the spatial classifier may be trained without the use of the co-training based learning framework.

Likewise, in other alternative embodiments, the air quality index module 224 may calculate the AQI of an area with respect to the pollutant by directly applying the temporal classifier to the temporal features of the area. For example, as described above, the temporal classifier may solve for the AQI for an area by applying a maximum likelihood learning technique to the temporal features of the area in view of other labeled areas. However, in other instances, the spatial classifier may use other classification techniques to infer the AQI based on the spatial features. In such alternative embodiments, the temporal classifier may be trained without the use of the co-training based learning framework.

The AQIs that are generated by a pair of classifiers including a co-trained spatial classifier and a temporal classifier, or generated by a separately trained spatial classifier or a separately trained temporal classifier, may be AQIs for a particular pollutant. Accordingly, multiple pairs of co-trained classifiers may be used by the inference components 218 to determine AQIs for multiple pollutants.

The location identification module 226 may identify preferred areas for building additional air quality monitor stations based on the AQIs of multiple pollutants over multiple areas in a region. In at least one embodiment, the location identification module 226 may initially calculate the deviation between the AQI level inferred by the air quality index module 224 and the AQI level inferred by linear interpolation for each of multiple pollutants. An entity (e.g., a government agency) may have no desire to build an air quality monitor station at an area if an interpolated AQI accurately reflects the air quality at the area, i.e., similar to the AQI determined using the co-trained spatial and temporal classifiers. On the contrary, the interpolated AQI may not accurately reflect the air quality at the area when the interpolated AQI deviates from the AQI determined using the co-trained spatial and temporal classifiers. In such an instance, the entity may decide to install an air quality monitor station at the area.

The linear interpolation may be performed by the linear interpolation module 228. The linear interpolation module 228 may implement a distance-weighted interpolation algorithm that uses the AQI values reported by the existing air quality monitor stations to interpolate air quality indices for areas without existing stations, as follows:

$${g}_{x} \cdot AQI = {\sum }_{i} \frac{{g}_{i} \cdot AQI \times \frac{1}{{d}_{x , i}}}{{\sum }_{i} \frac{1}{{d}_{x , i}}} \qquad ( 16 )$$

in which d_{x,i} denotes a geo-distance between an area x and the i-th monitor station. In various embodiments, the AQI values may be further translated into an AQI level designation in accordance with Table I.

The location identification module 226 may calculate the deviation between the AQI level inferred by the air quality index module 224 and the AQI level inferred by the linear interpolation module 228 for each pollutant at each of multiple predetermined time intervals. The calculation may be performed for each pollutant in each area at predetermined time intervals as shown below, in which m denotes a number of pollutants:

σ=|g·Q−g·Q′|={Δq₁,Δq₂, . . . ,Δq₁ₘ} (17)

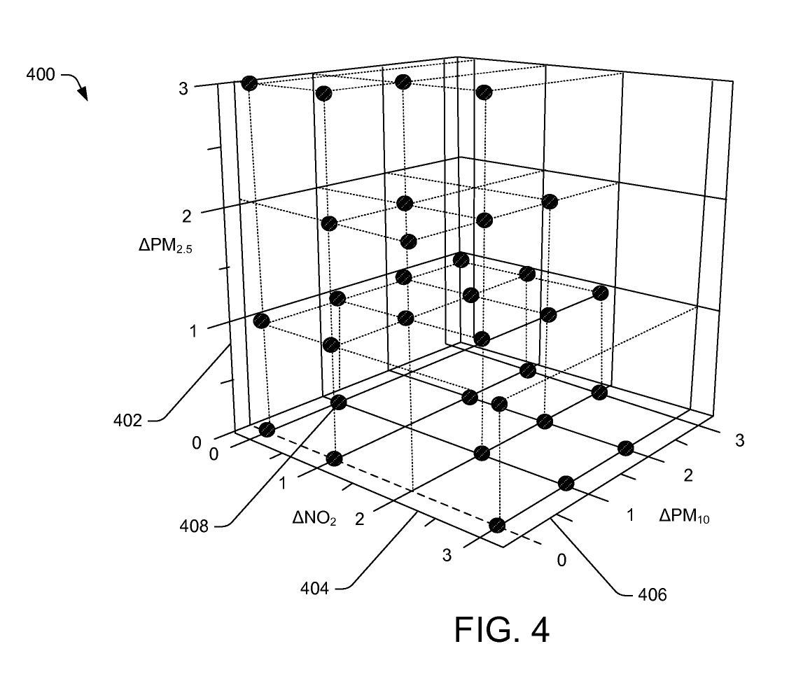

Subsequently, the location identification module 226 may represent an area as a point in a m-dimension space, where each dimension stands for a pollutant. For example, a set of two area may be represented as (1, 3, 4) and (3, 2, 0) of a first hour in a 3-dimensional (3D) space. Additional details regarding the representation of areas in the 3D space is illustrated with respect to FIG. 4.

FIG. 4 is a schematic diagram that illustrates an example 3-dimensional grid space 400 of deviations that assists in identifying areas in a region for air quality monitor station installation. In the example shown, the dimension 402 corresponds to the pollutant PM_{2.5}, the dimension 404 corresponds to the pollutant NO₂, and the dimension 406 corresponds to the pollutant Mo. Further, each of the points (e.g., point 408) may represent an area at which a pollutant is found. The points in each dimension are added over time. For example, the numerical value “1” indicates a passage of one hour, the numerical value “2” indicates a passage of two hours, the numerical value “3” indicates a passage of three hours, and so on and so forth.

Returning to FIG. 2, given the representation in an m-dimension space, the location identification module 226 may use a data-drive and non-parameter algorithm based on a skyline detection technique to find the points with salient gaps. A skyline may be defined as those points which are not dominated by any other point. A point may dominate another point if it is as good or better in all dimensions and better in at least one dimension.

Using the skyline detection technique, the location identification module 226 may identify a set of points (areas) for each hour. The location identification module 226 may count the occurrence of each area in the detected skylines through a predetermined time period, e.g., 3 months. Accordingly, the location identification module 226 may determine that the more frequently an area occurs in the detected skylines within the predetermined time period, the higher the probability that the area is a candidate area that is suitable for an air quality monitor station.

The location identification module 226 may further take into account the geo-distance between these candidate areas. In various embodiments, the location identification module 226 may use a Kernel Density Estimation (KDE) to infer the probability that an area is properly situated for an air quality monitor station based on the occurrences of the area in the detected skylines. KDE may be a non-parametric way to estimate the probability density function of a random variable. In other words, KDE solves a data smoothing problem based on a finite data sample. For example, given n points p₁, p₂, . . . , pₙ located in a 2-dimensional space, KDE may be used to estimate the intensity at an area x as follows:

$$f ( x ) = {\sum }_{i = 1}^{n} \frac{1}{{nh}^{2}} K ( \frac{{d}_{i , x}}{h} ) \qquad ( 18 )$$

in which d_{i,x} may represent a distance between pᵢ and x, h may represent a bandwidth and K( ) may be the kernel function whose value decays with increasing d_{i,x}.

In one instance, the location identification module 226 may use a Gaussian function as the kernel function and perform the computation according to a mean integrated squared error criterion. Further, the number of occurrences of an area is regarded as the number of points in the grid, and the coordinates of each point may be set to the center of the grid the point belongs to as follows:

$$K ( \frac{{d}_{i , x}}{h} ) = \frac{1}{\sqrt{2 π}} exp ( - \frac{{d}_{i , x}^{2}}{2 {h}^{2}} ) \qquad ( 19 )$$

Accordingly, the location identification module 226 may generate a heat map that shows the probability that each area is suitable for building an air quality monitor station. Thus, if an area with the highest probability is not available for a build, a decision maker (e.g., a government agency) may consider other areas around the area according to the heat map. Second, the estimated density determined by the location identification module 226 may group individual areas (e.g., grids) geospatially into multiple clusters. Thus, once an area in a cluster is determined to be suitable for building an air quality monitor station, the decision maker may refrain from considering other areas in the cluster as suitable.

The data store 230 may store spatial classifiers 234 and temporal classifiers 236, which may be co-trained for inferring AQIs for multiple pollutants. The data store 230 may further store the ST index 232, sorted lists, hash tables, and/or other data sources that are used by the components of the computing device 102.

The above example embodiments for inferring air quality index levels are described above as being implemented using a co-trained spatial classifier and a co-trained temporal classifier. However, in other embodiments, the inference of air quality index levels may be carried out using a spatial classifier that is trained using spatially-related data or a temporal classifier that is trained using temporally-related data, without the implementation of co-training. In such embodiments, the air quality index module 224 may be configured to derive an air quality index level for a pollutant in an area based on a spatial probability score or a temporal probability score.

### Example Processes

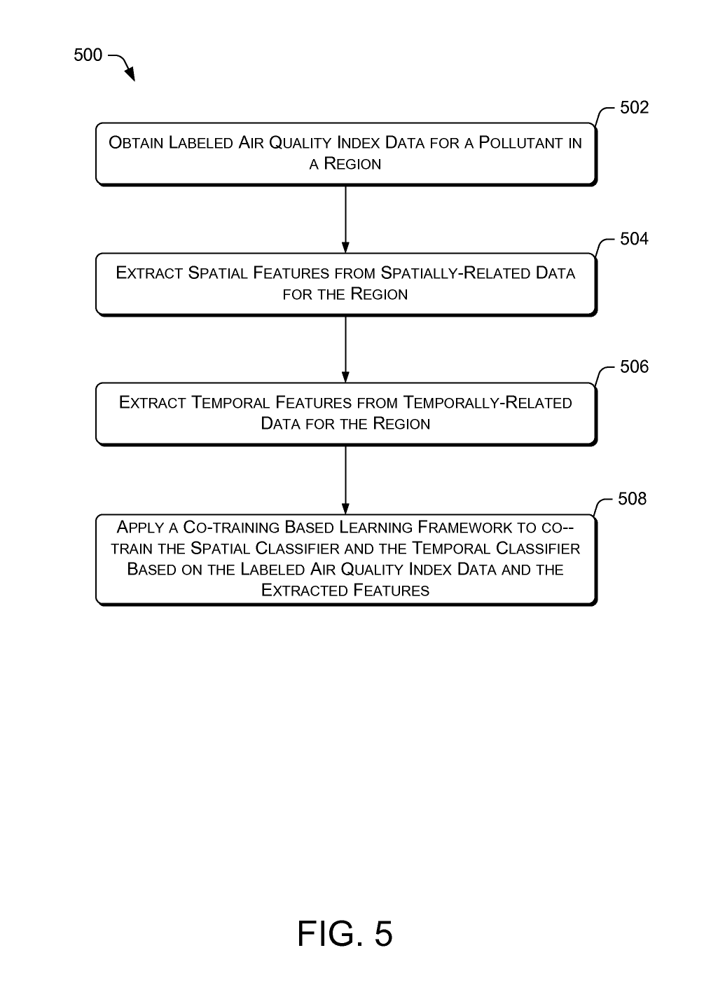

FIGS. 5-7 describe various example processes for using spatial and temporal features to infer air quality information for areas without air quality monitor stations. The order in which the operations are described in each example process is not intended to be construed as a limitation, and any number of the described operations may be combined in any order and/or in parallel to implement each process. Moreover, the operations in each of the FIGS. 5-7 may be implemented in hardware, software, and/or a combination thereof. In the context of software, the operations may represent computer-executable instructions that, when executed by one or more processors, cause one or more processors to perform the recited operations. The one or more processors may be included in individual computing devices or included in multiple computing devices that are, for example, part of a cloud. Generally, computer-executable instructions include routines, programs, objects, components, data structures, and so forth that cause the particular functions to be performed or particular abstract data types to be implemented. In other embodiments, the operations of each example process may be executed by a hardware logic circuit, such as a dedicated integrated circuit.

FIG. 5 is a flow diagram that illustrates an example process 500 for training a temporal classifier and a spatial classifier that are used to infer quality indices for a pollutant in a region based on multiple sources of data. At block 502, the labeled data extraction module 208 may obtain labeled air quality index data for a region. The labeled air quality data may be the air quality index data 118 that are obtained by air quality monitor stations for various areas (e.g., grids) in the region for a particular pollutant. Thus, a grid may be designated a labeled grid with respect to a pollutant when the grid has a corresponding air quality index for the pollutant. In some embodiments, the region may be an urban area.

At block 504, the spatial feature extraction module 210 may extract spatial features from spatially-related data for the region. In various embodiments, the spatially-related data may include road network data, points-of-interest (POI) data, and/or other data regarding fixed infrastructures in the region. The spatially-related data may be obtained from multiple sources, such as the unlabeled source data 112.

At block 506, the temporal feature extraction module 212 may extract temporal features from temporally-related data for the region. The temporally-related data may include data that changes over time in the region. For example, the temporally-related data may include automobile traffic data, human movement data, meteorological data, and/or so forth. The temporally-related data may be obtained from multiple sources, such as the unlabeled source data 112.

At block 508, the training module 216 may apply a co-training based learning framework to co-train the spatial classifier 116 and the temporal classifier 120 based on the labeled air quality index data 118, the extracted spatial features 110, and the extracted temporal features 114. In various embodiments, the training module 216 may initially train the spatial and temporal classifiers with respective features. Accordingly, because of the use of the labeled air quality index data 118, the spatial classifier and the temporal classifier may be trained with respect to the particular pollutant.

For example, the spatial classifier may be initially trained using the spatial features and the temporal classifier may be initially trained with the temporal features. The training module 216 may then apply the trained spatial classifier and the trained temporal classifier to infer unlabeled areas (e.g., grids) iteratively. The iterations may involve adding one or more of the most confidently classified examples into the labeled areas in the region for each subsequent training iteration round, until the remaining unlabeled areas in the region are labeled or a predetermined numbers of iteration rounds have been performed. At the end of the iterations, the training module 216 may return the fully trained spatial classifier and the fully temporal classifier.

However, in alternative embodiments, the training module 216 may simply train the spatial classifier or the temporal classifier with respect to their respective features for direct use in ascertaining the AQI of a pollutant. In other words, the training module 216 may train the spatial classifier or the temporal classifier independently using semi-supervised learning without the application of the co-training based learning framework.

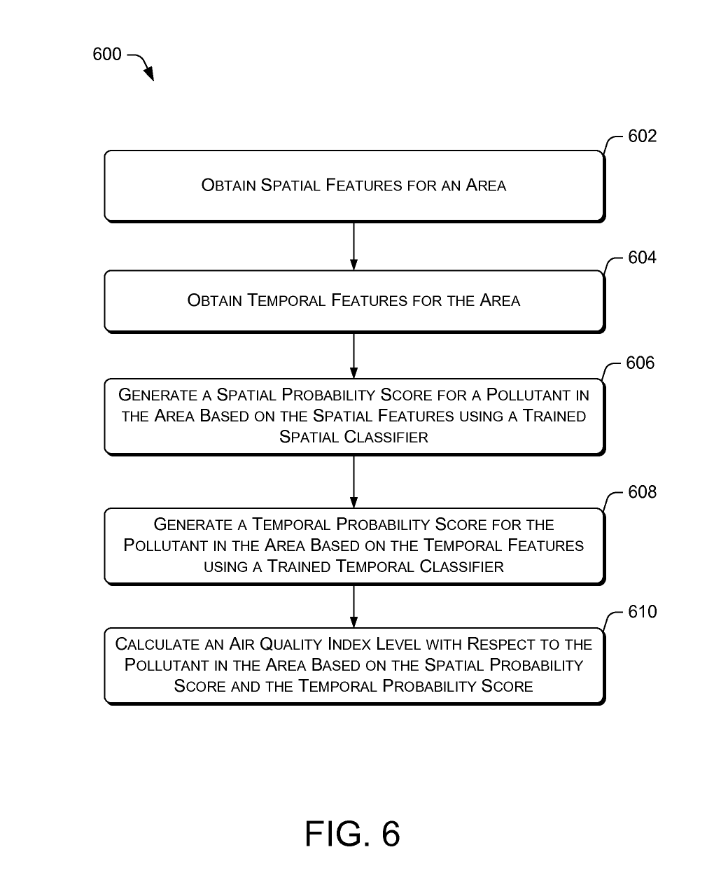

FIG. 6 is a flow diagram that illustrates an example process 600 for using a temporal classifier and a spatial classifier to infer an air quality index for a pollutant in an area based on multiple sources of data. At block 602, the spatial feature extraction module 210 may obtain spatial features for an area that is included in a region. In various embodiments, the spatial features may be obtained from spatially-related data in the observed data 122 for the area. The spatially-related data may include road network data, points-of-interest data, and/or other data regarding fixed infrastructures in the region.

At block 604, the temporal feature extraction module 212 may obtain temporal features for the area that is included in the region. In various embodiments, the temporal features may be obtained from temporally-related data in the observed data 122 for the area. The temporally-related data may include data that changes over time in the region. For example, the temporally-related data may include automobile traffic data, human movement data, meteorological data, and/or so forth.

At block 606, the spatial probability module 220 may generate a spatial probability score for a pollutant in the area based on the spatial features using a trained spatial classifier. In various embodiments, the trained spatial classifier may be the spatial classifier 116. The spatial probability score may represent the likelihood that the pollutant is present in the area.

At block 608, the temporal probability module 222 may generate a temporal probability score for a pollutant in the area based on the temporal features using a trained temporal classifier. In various embodiments, the trained temporal classifier may be the temporal classifier 120. The temporal probability score may represent the likelihood that the pollutant is present in the area.

At block 610, the air quality index module 224 may calculate an air quality index with respect to the pollutant in the area based on the spatial probability score and the temporal probability score. In various embodiments, the air quality index with respect to the pollutant may be calculated based on a product of the spatial probability score and the temporal probability score.

However, in some alternative embodiments, the air quality index module 224 may calculate the air quality index of an area with respect to the pollutant by directly applying the spatial classifier to the spatial features of the area. In such embodiments, the spatial classifier may be trained without the use of the co-training based learning framework. Likewise, in other alternative embodiments, the air quality index module 224 may calculate the air quality index of an area with respect to the pollutant by directly applying the temporal classifier to the temporal features of the area. In such embodiments, the temporal classifier may be trained without the use of the co-training based learning framework. Thus, in these alternative embodiments, the air quality index module 224 may generate an air quality index without performing the operations that are described in the blocks 606 and the block 608 of the process 600.

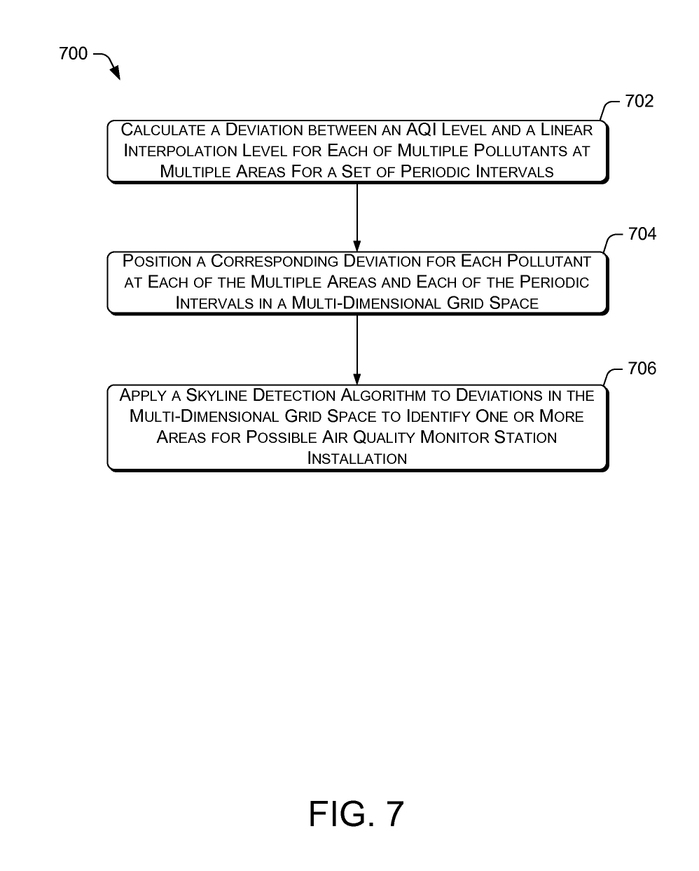

FIG. 7 is a flow diagram that illustrates an example process 700 for using deviations between obtained air quality index levels and linear interpolation levels of pollutants to determine possible areas for air quality monitor station installation. At block 702, a location identification module 226 may calculate a deviation between an AQI level and a linear interpolation level for each of multiple pollutants at multiple areas in a region for a set of periodic intervals. The AQI levels may be obtained by the air quality index module 224 using co-trained spatial classifier and temporal classifier. The linear interpolation levels may be obtained by the linear interpolation module 228.

At block 704, the location identification module 226 may position a corresponding deviation for each pollutant at each of the multiple areas and each of the periodic intervals in a multi-dimensional grid space. In one instance, the multi-dimensional grid space may be a 3-dimensional grid space in which each dimensional corresponds to a different pollutant, and the points in the grid space represent areas.

At block 706, the location identification module 226 may apply a skyline detection algorithm to the deviations in the multi-dimensional grid space to identify one or more areas for air quality monitor station installation. For example, the location identification module 226 may count the occurrence of each area in the detected skylines in the multi-dimensional grid space through a predetermined time period, e.g., 3 months, which encompasses the set of periodic intervals. Accordingly, the location identification module 226 may determine that the more frequently an area occurs in the detected skylines within the predetermined time period, the higher probability that the area is a candidate area that is suitable for a monitor station.

In summary, the techniques described herein may provide air quality data, such as air quality indices for a particular pollutant, for multiple areas without the addition of air quality monitor stations to those areas. Such reduction or elimination of the necessity to build air quality stations may provide monetary and energy savings. Further, the techniques may be used to determine areas at which future air quality monitor stations are to be established, such as in areas which the techniques predict worse than expected air quality.

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as exemplary forms of implementing the claimed subject matter.

What is claimed is:

1. One or more computer-readable media storing computer-executable instructions that are executed to cause one or more processors to perform acts comprising:
obtaining labeled air quality index data for a pollutant in a region from one or more air quality monitor stations;
extracting spatial features for the region from spatially-related data for the region, the spatially-related data including information associated with fixed infrastructures in the region;
extracting temporal features for the region from temporally-related data for the region, the temporally-related data including data for the region that changes over time; and
applying a co-training based learning framework to co-train a spatial classifier and a temporal classifier based at least on the labeled air quality index data, the spatial features for the region, and the temporal features for the region.

2. The one or more computer-readable media of claim 1, wherein the acts further comprise:
obtaining spatial features for an area in the region based on spatially-related data observed for the area;
obtaining temporal features for the area in the region based on temporally-related data observed for the area;
generating a spatial probability score for the pollutant in the area based at least on the spatial features using the spatial classifier;
generating a temporal probability score for the pollutant in the area based at least on the temporal features using the temporal classifier; and
calculating an air quality index level with respect to the pollutant in the area based at least on the spatial probability score and the temporal probability score.

3. The one or more computer-readable media of claim 2, wherein the calculating includes calculating the air quality index level based at least on a product of the spatial probability score and the temporal probability score.

4. The one or more computer-readable media of claim 2, wherein the spatially-related data observed for the area includes at least one of road network data or points-of-interest data, and wherein the temporally-related data observed for the area includes at least one of automobile traffic data, human movement data, or meteorological data.

5. The one or more computer-readable media of claim 2, wherein the area lacks an air quality monitor station that provides an air quality index level for the pollutant.

6. The one or more computer-readable media of claim 1, wherein the applying includes applying the co-training based learning framework to co-train the spatial classifier and the temporal classifier for inferring an air quality index level of the pollutant for an area in the region.

7. The one or more computer-readable media of claim 1, wherein the applying the co-training based learning framework includes:
training the spatial classifier with the spatial features for the region;
training the temporal classifier with temporal features for the region; and
applying the spatial classifier and the temporal classifier to infer unlabeled areas iteratively by adding one or more most confidently classified examples into labeled areas in the region for each subsequent training iteration round until remaining unlabeled areas in the region are labeled or a predetermined numbers of iteration rounds have been performed.

8. The one or more computer-readable media of claim 1, wherein the spatially-related data for the region includes at least one of road network data or points-of-interest data, and wherein the temporally-related data observed for the region includes at least one of automobile traffic data, human movement data, or meteorological data.

9. The one or more computer-readable media of claim 1, wherein the spatial classifier is an artificial neural network (ANN) classifier, and wherein the temporal classifier is one of a linear-chain conditional random field (CRF) classifier, a hidden Markov model (HMM) classifier, or a maximum entropy Markov model classifier.

10. A computer-implemented method, comprising:
applying a co-training based learning framework to co-train a spatial classifier and a temporal classifier based at least on labeled air quality index data from one or more air quality monitor stations in a region, a set of spatial features associated with the region, and a set of temporal features associated with the region;
obtaining an additional set of spatial features for an area in the region based on spatially-related data observed for the area; obtaining an additional set of temporal features for the area in the region based on temporally-related data observed for the area;
generating a spatial probability score for a pollutant in the area based at least on the additional set of spatial features for the area using the spatial classifier; generating a temporal probability score the pollutant in the area based at least on the additional set of temporal features for the area using the temporal classifier; and
calculating an air quality index level with respect to the pollutant in the area based at least on the spatial probability score and the temporal probability score.

11. The computer-implemented method of claim 10, further comprising:
obtaining the labeled air quality index data for the pollutant in the region from one or more air quality monitor stations;
extracting the spatial features associated with the region from spatially-related data for the region, the spatially-related data including information associated with fixed infrastructures in the region; and extracting the temporal features for the region from temporally-related data for the region, the temporally-related data including data for the region that changes over time.

12. The computer-implemented method of claim 11, wherein the spatially-related data for the region includes at least one of road network data or points-of-interest data, and wherein the temporally-related data observed for the region includes at least one of automobile traffic data, human movement data, or meteorological data.

13. The computer-implemented method of claim 10, wherein the applying the co-training based learning framework includes:
training the spatial classifier with the set of spatial features associated with the region;
training the temporal classifier with the set of temporal features associated with the region; and
applying the spatial classifier and the temporal classifier to infer unlabeled areas iteratively by adding one or more most confidently classified examples into labeled areas in the region for each subsequent training iteration round until remaining unlabeled areas in the region are labeled or a predetermined numbers of iteration rounds have been performed.

14. The computer-implemented method of claim 10, wherein the spatially-related data observed for the area includes at least one of road network data or points-of-interest data, and wherein the temporally-related data observed for the area includes at least one of automobile traffic data, human movement data, or meteorological data.

15. The computer-implemented method of claim 10, further comprising:
calculating a deviation between an air quality index level and a corresponding linear interpolation level for each of multiple pollutants at a plurality of areas for a set of periodic intervals;
positioning a corresponding deviation for each pollutant at each of the plurality of areas and each of the periodic intervals in a multi-dimensional grid space; and
applying a skyline detection algorithm to deviations in the multi-dimensional grid space to identify one or more areas for air quality monitor station installation.

16. The computer-implemented method of claim 15, wherein the applying the skyline detection algorithm includes:
counting occurrences of each area in detected skylines in the multi-dimensional grid space through a predetermined time period that encompasses the set of periodic intervals; and
determining that an area is a candidate location that is suitable for air quality monitor station installation based at least on a frequency that the area occurs in the detected skylines within the predetermined time period.

17. A device, comprising:
one or more processors;
a memory that includes a plurality of computer-executable components that are executable by the one or more processors, comprising:
a spatial feature extraction component that obtains spatial features for an area in a region based on spatially-related data observed for the area;
a temporal feature extraction component that obtains temporal features for the area in the region based on temporally-related data observed for the area;
and
an air quality index component that calculates an air quality index level with respect to the pollutant in the area by applying a spatial classifier to the spatial features or applying a temporal classifier to the temporal features.

18. The device of claim 17, wherein the spatial feature extraction component further extracts spatial features for the region from spatially-related data for the region, the spatially-related data including information on fixed infrastructures in the region, and wherein the temporal feature extraction component further extracts temporal features for the region from temporally-related data for the region, the temporally-related data including data for the region that changes over time.

19. The device of claim 17, further comprising at least one of:
a labeled data extraction component that obtains labeled air quality index data for the pollutant in the region from one or more air quality monitor stations;
a spatial probability component that generates a spatial probability score for a pollutant in the area based at least on the spatial features for the area using the spatial classifier;
a temporal probability component that generates a temporal probability score for the pollutant in the area based at least on the temporal features for the area using the temporal classifier; and
a co-training component that applies a co-training based learning framework to co-train the spatial classifier and the temporal classifier based at least on the labeled air quality index data, the spatial features for the region, and the temporal features for the region,
wherein the air quality index component further calculates an additional air quality index level with respect to the pollutant in the area based at least on the spatial probability score or the temporal probability score.

20. The device of claim 17, further comprising a location identification component that performs acts including:
calculating a deviation between an air quality index level and a corresponding linear interpolation level for each of multiple pollutants at a plurality of areas for a set of periodic intervals;
positioning a corresponding deviation for each pollutant at each of the plurality of areas and each of the periodic intervals in a multi-dimensional grid space; and
applying a skyline detection algorithm to deviations in the multi-dimensional grid space to identify one or more areas for air quality monitor station installation.
